(19) United States
(12) Patent Application Publication
(10) Pub. No.: US 2019/0159146 A1
(43) Pub. Date: May 23, 2019

(54) Radio Access Network Node, Radio Node, And Methods Performed Therein

(71) Applicant: Telefonaktiebolaget LM Ericsson (publ), Stockholm (SE)

(72) Inventors: Ying Sun, Sundbyberg (SE); Franz Heiser, Järfälla (SE); Jianwei Zhang, Solna (SE); Johan Zhang, Solna (SE)

(21) Appl. No.: 16/095,005

(22) PCT Filed: May 12, 2016
(86) PCT No.: PCT/SE2016/050429

§ 371 Date: Oct. 19, 2018

(51) Int. Cl. H04W 56/00; H04W 8/00; H04W 16/14; H04W 72/04

(52) U.S. Cl. CPC H04W 56/001; H04W 72/044; H04W 16/14; H04W 8/005

(57) ABSTRACT

Embodiments herein relate to a method performed by a radio node (13) for managing communication of one or more wireless devices (10) within a wireless communication network (1); which wireless communication network (1) comprises a radio access network node (12) serving the radio node (13). The radio node (13) receives an indication of radio resources out of a total spectrum of radio resources controlled by the radio access network node (12) for communication over a first radio interface using a first radio access technology, which indicated radio resources are allocated to the radio node (13) from the radio access network node (12) for communication over a second radio interface, which second radio interface uses a second radio access technology being different than the first radio access technology. The radio node (13) allocates at least part of the indicated radio resources for communication to and/or from the one or more wireless devices (10) over the second radio interface.

### TECHNICAL FIELD

Embodiments herein relate to a radio access network node, a radio node and methods performed therein. In particular embodiments herein relate to managing and handling communication of one or more wireless devices in a wireless communication network.

### BACKGROUND

In a typical wireless communication network, wireless devices, also known as wireless communication devices, mobile stations, stations (STA) and/or user equipments (UE), communicate via a Radio Access Network (RAN) to one or more core networks (CN). The RAN covers a geographical area which is divided into service areas or cell areas, with each service area or cell area being served by a radio access network node such as a radio access node e.g., a Wi-Fi access point or a radio base station (RBS), which in some networks may also be denoted, for example, a “NodeB” or “eNodeB”. A service area or cell area is a geographical area where radio coverage is provided by the radio access network node. The radio access network node communicates over an air interface operating on radio frequencies with the wireless device within range of the radio access network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several radio access network nodes may be connected, e.g., by landlines or microwave, to a controller node, such as a radio network controller (RNC) or a base station controller (BSC), which supervises and coordinates various activities of the plural radio access network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access network nodes are directly connected to the EPC core network rather than to RNCs. In general, in E-UTRAN/LTE the functions of an RNC are distributed between the radio access network nodes, e.g. eNodeBs (eNB) in LTE, and the core network. As such, the RAN of an EPS has an essentially “flat” architecture comprising radio access network nodes connected directly to one or more core networks, i.e. they are not connected to RNCs. To compensate for that, the E-UTRAN specification defines a direct interface between the radio access network nodes, this interface being denoted the X2 interface. EPS is the Evolved 3GPP Packet Switched Domain.

Three types of network architectures supported by 3GPP LTE are shown in FIGS. 1a-1c. In FIG. 1a the conventional LTE architecture is shown where the communication between two wireless devices relies on the network infrastructure, e.g. an eNB connected to a serving gateway (SGW) or to a Packet Data Network Gateway (PGW), of the network. For this network architecture, large coverage can be achieved but with long end to end latency performances. In FIG. 1b, wireless devices of LTE have a support of a WiFi tethering functionality. When the WiFi tethering functionality is switched on, the communications between tethering wireless devices, which have not LTE network coverage, will be supported by the LTE network via LTE in the covered wireless device. FIG. 1c describes a 3GPP supported Device to Device (D2D) network architecture. The radio access network node allocates an isolated resource pool to a group of wireless devices that are able to setup direct communication between each other. The communication between the two wireless devices can be setup without involving network infrastructure. Thus, short latency is possible to be achieved.

Popular non 3GPP based Machine Type Communication (MTC) technologies are often proprietary technologies deployed in the license-exempt bands of Low Power Wide Area Networks, i.e. SigFox or LoRa. The SigFox or LoRa devices are connected with star-topologies, which means the SigFox or LoRa devices are communicating with one gateway Host. Large coverage is achieved by transmitting low bitrates, e.g. <10 kbits/s, with long transmission time. The connected SigFox or LoRa devices can access to the internet or other services via SigFox/LoRa gateway hosts or “base stations”, see FIG. 2.

These previous solutions may all lead to a potential unnecessary complicated solution to support co-existence of some or all these and other future services.

### SUMMARY

An object of embodiments herein is to provide a mechanism for supporting services in the wireless communication network in an efficient manner.

According to an aspect the object is achieved by providing a method performed by a radio node for managing communication of one or more wireless devices within a wireless communication network. The wireless communication network comprises a radio access network node serving the radio node. The radio node receives an indication of radio resources out of a total spectrum of radio resources controlled by the radio access network node for communication over a first radio interface using a first radio access technology The indicated radio resources are allocated to the radio node from the radio access network node for communication over a second radio interface, which second radio interface uses a second radio access technology being different than the first radio access technology. The radio node allocates at least part of the indicated radio resources for communication to and/or from the one or more wireless devices over the second radio interface.

According to another aspect the object is achieved by providing a method performed by a radio access network node for handling communication of one or more wireless devices within a wireless communication network. The radio access network node is serving a radio node in the wireless communication network. The radio access network node allocates radio resources dedicated for the radio node, which allocated radio resources are out of a total spectrum of radio resources controlled by the radio access network node for communication over a first radio interface using a first radio access technology. The radio resources are allocated to the radio node from the radio access network node for communication over a second radio interface, which second radio interface uses a second radio access technology being different than the first radio access technology. The radio access network node transmits, to the radio node, an indication of the allocated radio resources.

According to yet another aspect the object is achieved by providing a radio node for managing communication of one or more wireless devices within a wireless communication network. The wireless communication network comprises a radio access network node configured to serve the radio node. The radio node is configured to receive an indication of radio resources out of a total spectrum of radio resources controlled by the radio access network node for communication over a first radio interface using a first radio access technology. The indicated radio resources are allocated to the radio node from the radio access network node for communication over a second radio interface, which second radio interface is configured to use a second radio access technology being different than the first radio access technology. The radio node is further configured to allocate at least a part of the indicated radio resources for communication to and/or from the one or more wireless devices over the second radio interface.

According to still another aspect the object is achieved by providing a radio access network node for handling communication of one or more wireless devices within a wireless communication network. The radio access network node is configured to serve a radio node in the wireless communication network. The radio access network node is configured to allocate radio resources dedicated for the radio node, which allocated radio resources are out of a total spectrum of radio resources controlled by the radio access network node for communication over a first radio interface configured to use a first radio access technology. The radio resources are allocated to the radio node from the radio access network node for communication over a second radio interface, which second radio interface is configured to use a second radio access technology being different than the first radio access technology. The radio access network node is configured to transmit, to the radio node, an indication of the allocated radio resources.

It is furthermore provided herein a computer program comprising instructions, which, when executed on at least one processor, cause the at least one processor to carry out any of the methods above, as performed by the radio node or the radio access network node. It is additionally provided herein a computer-readable storage medium, having stored thereon a computer program comprising instructions which, when executed on at least one processor, cause the at least one processor to carry out the method according to any of the methods above, as performed by the radio node or the radio access network node.

Embodiments herein introduce an efficient solution providing a radio node that gets allocated radio resources and actively locally allocates for communication within radio coverage of the radio node, i.e. performs a local radio resource management of the allocated radio resources. Thus, embodiments herein provides a solution to support co-existence of some or all services in an efficient manner.

### BRIEF DESCRIPTION OF THE DRAWINGS

Embodiments will now be described in more detail in relation to the enclosed drawings, in which:

FIGS. 1a-1c show different wireless communication network solutions according to prior art;

FIG. 2 shows a wireless communication network solution according to prior art;

FIG. 3 is a schematic overview depicting a wireless communication network according to embodiments herein;

FIG. 4 is a combined flowchart and signalling scheme according to embodiments herein;

FIG. 5 is a flowchart depicting a method performed by a radio node according to embodiments herein;

FIG. 6 is a flowchart depicting a method performed by a radio access network node according to embodiments herein;

FIG. 7 is a schematic overview depicting a solution according to an embodiment herein;

FIG. 8 is a schematic overview depicting a solution according to an embodiment herein;

FIG. 9 is a schematic overview depicting a solution according to an embodiment herein;

FIG. 10 is a schematic overview depicting a solution according to an embodiment herein;

FIG. 11 is a schematic overview depicting a solution according to an embodiment herein;

FIG. 12 is a block diagram depicting a radio node according to embodiments herein; and

FIG. 13 is a block diagram depicting a radio access network node according to embodiments herein.

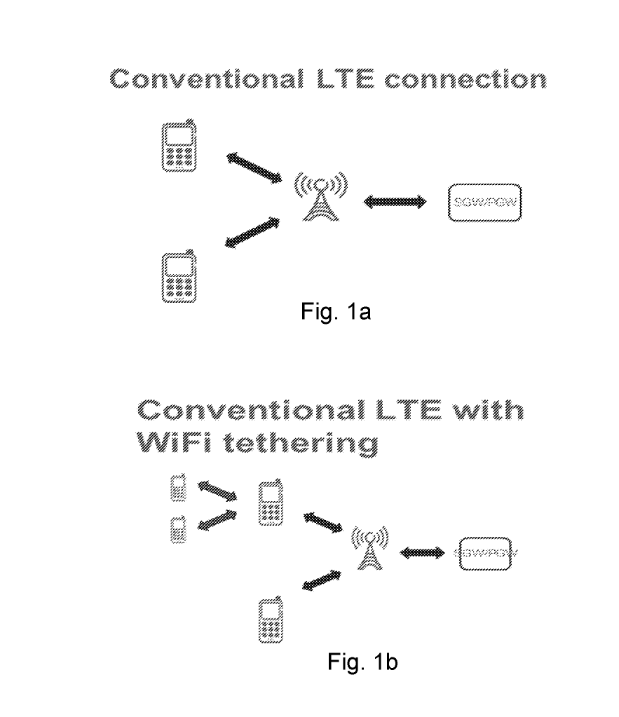

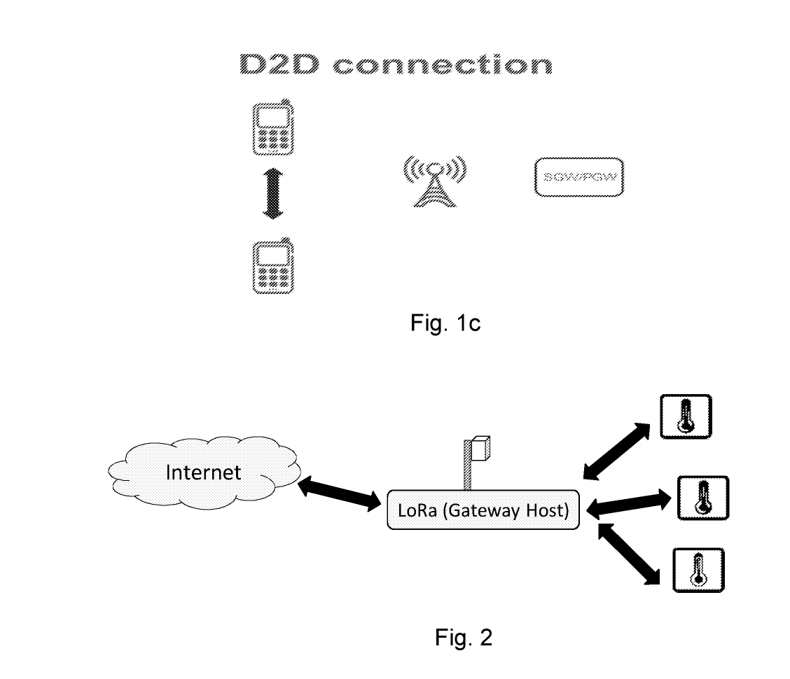

### DETAILED DESCRIPTION

As part of developing embodiments herein a plurality of problems have been identified. A problem may arise in the future when traditional wireless network operators want to integrate services from other industries into the licensed spectrum, especially for the industry which requires wireless communication for the critical application with ultra-short latency and high reliability. In the traditional wireless network architecture, latency is not a focus and the traditional wireless network architecture aims at a generic solution to support large scale coverage which does not consider the traffic characteristics and wireless devices characteristics. The communication between the wireless devices will involve the whole network, including the core network, independent of the distance of the wireless devices. So potential problems may be
Long latency, since the data transmission path is always including the highest layer of the network.
Inefficient radio resource utilization.
Potential unnecessarily complicated solution to support co-existence of all services.
All wireless devices supported in an LTE network will be LTE standard compliant and all D2D terminals have to have a Subscriber Identity Module (SIM) card or any type of network user identifier tag, which is provided by wireless network operator.
Tethering functionality will be able to support the communication of non-LTE compliant traffic in LTE network, but direct communications between tethering wireless devices are not possible. Moreover, as WiFi is using unlicensed spectrum, no Quality of service (QoS) can be guaranteed, thus, services such as Voice Over Internet Protocol (VoIP), Critical machine type communication (C-MTC) cannot be supported.

Furthermore, problems of a D2D connection architecture may be:
Limited coverage and low reliability. This is because typically wireless devices have much lower transmit power and air interface efficiency.
Lack of reliable resource allocation scheme to support multiple wireless devices. Multiple wireless devices will share the same resource pool configured by the radio access network node. Collision may happen when two wireless devices transmit simultaneously with the same resources. That will cause higher block error rate.
All D2D terminals need to comply with LTE standard and have an identity that is known by the network. All D2D terminals have to have a wireless network identifier, which is provided by wireless network operator. The restrictions that all wireless devices have to be standard compliant and known by the network, may limit the business cases. Many other industries, such as public transportation, hospitals, mining industries etc, might prefer to get support by the conventional wireless network provider transparently without being interfered by other industries.
Inefficient resource utilization for localized communications. For the localized traffic, where the communication between receiver and transmitter are known and in the coverage of the same cell, there is no need to have the context of the wireless device kept in the network side. In C-MTC industry it is very common that wireless devices connected and located are well defined. In many cases those wireless devices are localized within the coverage in the same cell, the communications are among those devices in the cell. For example, a mining robot with a communication function, being an example of a wireless device, is controlled by a controlling station which is nearby and the communication between them is wireless at a given frequency spectrum. It is frequency spectrum to be allocated by the wireless network but the context of the mining robot does not need to be known by the network. The current D2D framework is not resource efficient from that perspective.

One or more problems of existing Massive MTC (M-MTC) solutions, such as SigFox, LoRa and 3GPP M-MTC Narrow Band (NB)-LTE concepts may be:
Both SigFox and LoRa are operating in license-exempt frequency spectrum, which provides for no quality of service guarantee, as opposed to a licensed operation, whereby the network operator has paid a fee for exclusive access to the frequency spectrum being used. This means that services provided by SigFox and LoRa cannot be utilized for critical MTC which requires ultra-short latency and ultra-high reliability.
3GPP LTE Category M (Cat M) and NB-LTE has an objective to provide M-MTC low cost devices with extended coverage in the licensed spectrum of frequencies, which is operated by wireless network operators. However, ultra latency and ultra-reliability requirement is still hard to be met due to the following reasons:
a. Traditional large scale network architecture: Independent of where wireless devices are located the communication between wireless devices will involve a complete network structure, which includes the core network.
b. Large number of transmission repetitions to support coverage enhancement that will introduce long latency.

Embodiments herein provide a radio node with a local radio resource management function and a radio access network node that allocates radio resources out of a total spectrum of radio resources controlled by the radio access network node for communication over a first radio interface using a first radio access technology, e.g. LTE. The radio resources are allocated to the radio node for communication over a second radio interface, which second radio interface uses a second radio access technology being different than the first radio access technology, e.g. NB LTE. Thus, embodiments provide a solution to support co-existence of services of different RATs in an efficient manner.

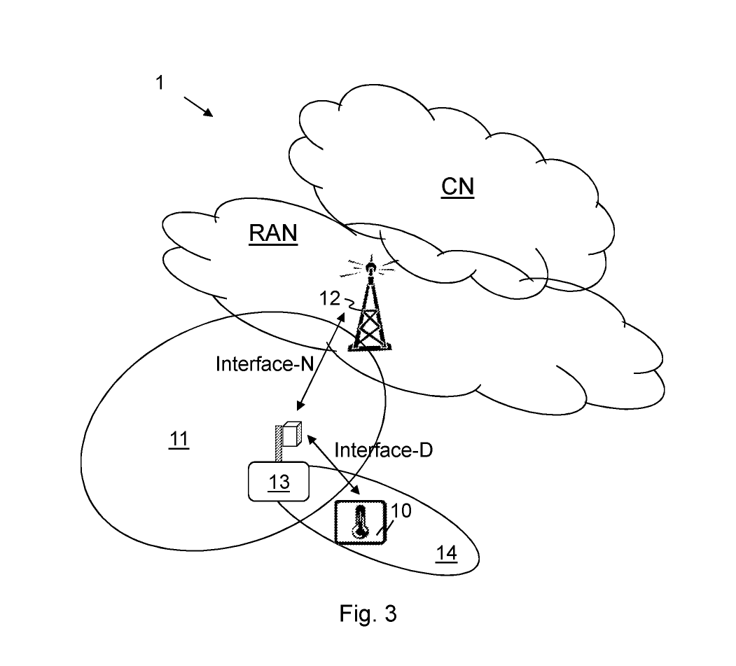

Embodiments herein relate to wireless communication networks in general. FIG. 3 is a schematic overview depicting a wireless communication network 1. The wireless communication network 1 comprises one or more RANs and one or more CNs. The wireless communication network 1 may use a number of different technologies, such as Wi-Fi, Long Term Evolution (LTE), LTE-Advanced, 5G, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices e.g. a wireless device such as a mobile station, a non-access point (non-AP) STA, a STA, a user equipment and/or a wireless terminals, communicate via one or more Access Networks (AN), e.g. RAN, to one or more CN or directly with one another. It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, temperature sensor, robot device, relay, mobile tablets or even a small base station communicating within a cell or similar.

The wireless communication network 1 comprises a radio access network node 12 providing radio coverage over a geographical area, a first service area 11, of a first radio access technology (RAT), such as LTE, UMTS or similar. The radio access network node 12 may be a transmission and reception point e.g. a radio network node such as a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the area served by the radio access network node 12 depending e.g. on the first radio access technology and terminology used. The radio access network node 12 may be referred to as a serving access point and communicates with wireless devices and radio nodes with DL transmissions to the wireless devices and radio nodes and UL transmissions from the wireless devices or the radio nodes.

Embodiments herein introduce a new node, referred to as a radio node 13 or an MTC-node, which radio node 13 supports a spectrum of functionalities such as both part of D2D wireless device functionalities and radio access network node functionalities. To the core network and the radio access network node 12, the proposed radio node 13 is operated as if it is a special wireless device which supports D2D wireless device functionalities and requests radio resources, and the radio node 13 may also contain some functionalities of a radio access network node, such as a radio resource management algorithm, receiving and transmitting algorithms, backhauling etc. The radio access network node 12 allocates radio resources, e.g. a group of radio resources such as frequency, time and/or power resources, dedicated for the radio node 13 or to a group of radio nodes. This allocation may be predefined at the radio access network node 12. The radio access network node 12 then transmits to the radio node 13, an indication of the allocated radio resources.

The radio node 13 provides radio coverage over a geographical area, a second service area 14, of a second RAT, such as LTE, Wi-Fi, WiMAX or similar over the allocated radio resources. The radio node 13 may be a transmission and reception point e.g. a radio network node such as a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the area served by the radio node 13 depending e.g. on the second radio access technology and terminology used. The first and second RAT are of different RATs. It should be noted that a service area may the denoted as ‘cell’, beam, beam group, or similar to define an area of radio coverage.

To the network e.g. RAN nodes or CN nodes, the radio node 13 is operated as a super terminal and the radio node 13 receives the indication of the radio resources, or resource pool, allocated by the radio access network node 12 based on a wireless network protocol. To all the wireless devices, such as the wireless device 10, served by the radio node 13, the radio node 13 is operating as a scheduler/controller to further allocate the dedicated allocated radio resources from the given resource pool to the communications of the wireless devices. The wireless devices within the second service area 14, allocated with the radio resources, will be able to set up direct communications between each other performing D2D communication over radio resources intended for e.g. communication over a licensed spectrum. Ultra-short latency may be obtained with the direct communications. The wireless devices, e.g. the wireless device 10, within the coverage of the radio node 13 can be provided with QoS since the communications between the wireless devices are in the licensed spectrum protected by wireless operator controlled radio access network node. The wireless devices within the coverage of the radio node 13 may further be QoS differentiated since the radio node 13 may have implemented a QoS based scheduler and the radio resources may be allocated at the radio node 13 based on the differentiated QoS requirements.

Embodiments herein may further decouple an air interface between the radio node 13 to the radio access network node 12, denoted the first radio interface or Interface-N, and an air interface between the radio node 13 to the wireless device 10 or group of wireless devices denoted as the second radio interface or interface-D. Different air interface protocol may be used at these interfaces and the air interface resource usage may be shared between the two RATs and coordinated. Thus the radio node 13 functions e.g. as a licensed band air interface protocol converter, which potentially is programmable and may convert any air interface protocol within commercial wireless network licensed band. The first radio interface follows wireless network air interface protocol, such as LTE air interface protocol. The second radio interface may be sharing the same frequency band, or at least a part, as the first radio interface but can be programmable as any protocol based on customer needs. For example, it could be a specific air interface protocol designed for a specific C-MTC industry, or a 3GPP D2D protocol, a Wi-Fi protocol, or a 5G protocol.

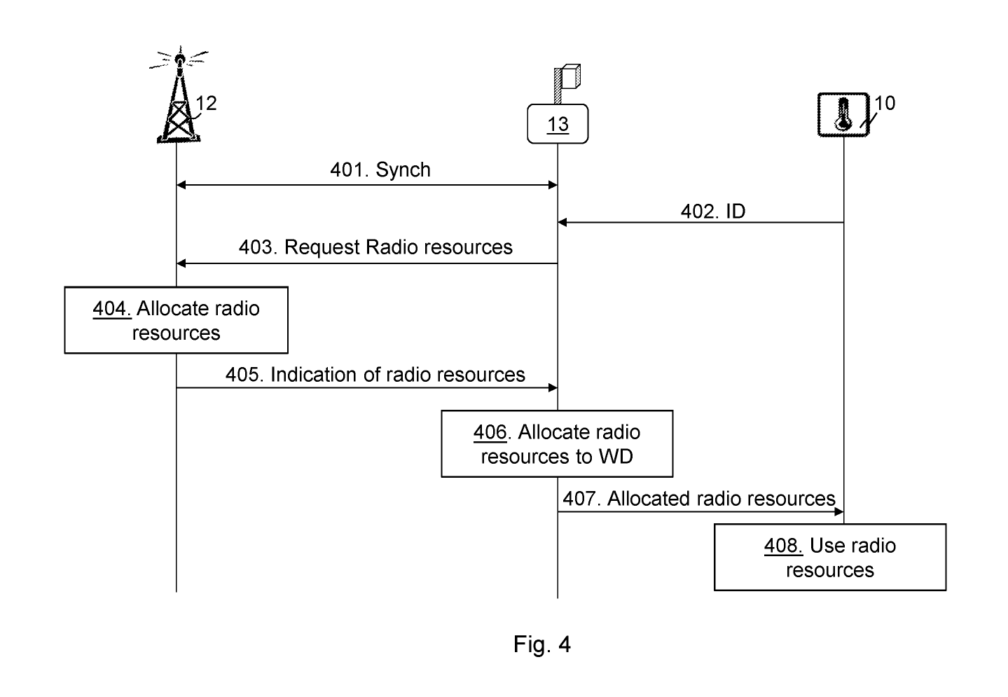

FIG. 4 is a combined flowchart and signaling scheme according to embodiments herein.

Action 401. When e.g. switching on the radio node 13, the radio node 13 gets synchronized with the radio access network node 12 and the radio access network node 12 will allocate the radio resources used for the wireless device 10 or a group of wireless devices comprising the wireless device 10. A group of wireless devices may be predefined that have same characteristics or are from the same enterprise. For example, traditional wireless network services, such as Mobile Broadband (MBB) traffic, Voice over LTE (VoLTE), video, and best effort traffic, are configured as a commercial traffic group of wireless devices served by mobile broad band network provider enterprise. Wireless devices, e.g. C-MTC devices, from the same enterprise belong to a same traffic group, e.g. remote automatic mining robots and a controlling station are configured into a mining enterprise group, or remote operating robots and a controlling station in a hospital are configured as a medical C-MTC group. Different enterprises may purchase one or more radio nodes to provide wireless coverage for an intended area. Each radio node, e.g. the radio node 13, may have been preconfigured with a needed software package that is specifically designed based on QoS requirements of the enterprise traffic characteristics. Wireless network node ID, a network user identifier tag, or mobile identifier, e.g. SIM card, may only be required in the radio node 13, the other wireless devices within the device group is not required to be identified by wireless communication network 1. The wireless devices belonging to the group might or might not be 3GPP LTE compliant or might not be within the LTE coverage, the radio access network node 12 might or might not have the knowledge of the existing devices.

Action 402. The radio node 13 may discover if there are any wireless devices or other radio nodes configured within the second service area 14. One example of such procedure is to use D2D synchronization procedure defined by 3GPP. When one or more wireless devices or radio nodes are synchronized or discovered, the communication group, comprising the radio node 13 and the wireless devices, is considered to be ready to exchange information within. The identifier of the wireless devices, the identifiers of the radio node and identifiers of the radio node's connected devices are exchanged among the connected radio node and its wireless devices. The routing path/map of one wireless device to all the other wireless devices may be made.

Action 403. To synchronize with the radio access network node 12 in the uplink the radio node 13 may perform a traditional random access procedure over the first radio interface disclosed as Interface-N in FIG. 3 and become Radio Resource Control (RRC) connected. The radio node 13 is RRC connected when an RRC connection is established between the radio node 13 and the radio access network node 12. The radio node 13 may request radio resources e.g. air interface resources, within the total spectrum of radio resource of the radio access network node 12 based on a radio resource usage for communication and information of the wireless device 10, e.g. being a C-MTC device. Hence, the radio node 13 may transmit a radio resource request to the radio access network node 12.

Action 404. The radio access network node 12 then allocates radio resources dedicated for the radio node 13, which allocated radio resources are out of the total spectrum of radio resources controlled by the radio access network node 12. When the radio access network node 12 allocates the radio resources or pool of radio resource to the radio node 13, e.g. of a group of wireless devices, the radio access network node 12 may block the usage of the allocated radio resources for other wireless devices or groups of wireless devices. Potentially, it is also possible for the radio access network node 12 to multiplex different groups/wireless devices in the same radio resources or pool of radio resources if they are spatially well isolated, e.g. different beams. It could also be geographically separated wireless devices covered by different radio nodes and/or radio access network nodes but sharing the same spectrum. For example some of the wireless devices covered by the radio access network node 12 which are very isolated from the other wireless devices served by the radio node 13. Since the radio access network node 12 and the radio node 13 and thus the wireless devices are far away from each other, the wireless devices can use the same radio resources without interfering each other. In some embodiments, the radio access network node 12 may allocate two sets of radio resources to the radio node 13 or a group of wireless devices of the radio node 13. One set of radio resources is the pool of radio resources used for the communications between wireless devices within the group. It is allocated to the wireless devices within the group in the coverage of the radio access network node 12 including the radio node 13. The radio node 13 is predefined as a device group controller and controls the resource allocation for the communication of all the wireless devices in its coverage. Another set of radio resources allocated to the radio node 13 is used for transmission of aggregated data from multiple wireless devices if those wireless devices are outside the coverage of the radio access network node 12. The radio access network node 12 may allocate the radio resources statically, semi-statically or dynamically and the radio access network node 12 may, as stated above, block the allocated radio resource pool for the usage by other wireless devices.

The radio access network node 12 may allocate and control other air interface resources on the radio node 13. For example, the radio access network node 12 may control the maximum uplink and/or downlink transmit power of the radio node 13 for each radio resource allocated to the radio node 13.

Action 405. The radio access network node 12 transmits an indication of the allocated radio resources to the radio node 13, e.g. as a response to the request or a similar message. The indication may comprise an allocated spectrum of frequencies, times, powers or similar.

Action 406. The radio node 13 allocates at least a part of the radio resources to the wireless device 10 or a group of wireless devices. The radio node 13 may allocate radio resources from the allocated radio resources to e.g. the wireless devices within the group. The radio node 13 may further control the maximum resources, e.g. power, usage among all wireless devices to follow interference criteria. When multiple wireless devices are served by the radio node 13, the radio node 13 may have a functionality to prioritize traffic between different wireless devices and different radio nodes e.g. when allocating radio resources based on QoS requirement of each wireless device.

Action 407. The radio node 13 informs the wireless device 10 of the allocated radio resources for e.g. D2D communication or MTC communication.

Action 408. The wireless device 10 then uses the allocated radio resources for communication. Communication between the radio node 13 and the wireless device 10, and/or between wireless devices, and/or between the radio nodes may thus be carried out at the allocated radio resources.

The radio node 13 may connect to other radio nodes in a proximity (neighboring) area. The communication between the radio nodes may e.g. follow a 3GPP D2D protocol. The radio node 13 may hold served context information of the wireless devices and exchange the served context information among all radio nodes. The radio node 13 may have a routing functionality to find a shortest path based on a known communication pair of wireless devices. If the communication pair is within its own proximity coverage, direct link may be setup between the wireless devices using the given radio resources assigned or allocated by the radio node 13. If the communication pair is within the group of wireless devices, which is served by other radio nodes in the proximity area of the radio node 13, the radio node 13 may route the communication information to the intended wireless devices passing through the radio nodes with the shortest path. If the communication pair involves a wireless device that is not found in the group of wireless devices or the radio node associated to the wireless device is not found in the proximity area of the radio node 13, the radio node 13 may route the communication information and the intended information to the radio access network node 12 for higher layer functionality.

The radio node 13 may have a mobility functionality such as supporting cell selection and handover procedure.

The radio node 13 may need an access right to be admitted services in the wireless communication network, e.g. the radio node 13 may need a SIM card for the wireless communication network to gain access to the services in the first service area 11. The wireless devices may however only use a service from a local communication with the radio node 13 in the second service area 14 and thus the wireless devices do not need to have access right to wireless communication network, and then no SIM card is needed for each wireless device. If, however, a wireless device such as the wireless device 10 also needs to be able to communicate within the wireless communication network a SIM card or a similar network user identifier tag may be needed for its admission into the RAN.

Embodiments herein may support data traffic based on a D2D communication framework. Thus, ultra-short latency is possible by using direct communications between wireless devices without involving radio access network nodes or radio nodes. High reliability is achieved by introducing the radio node 13 supporting both direct communications among a group of wireless devices, and more reliable radio resource allocation scheme.

Further advantages of embodiments herein are:

A possibility to integrate any industry segments using any protocol to commercial wireless communication networks, at a given frequency spectrum by mobile operators but without exposing important information to mobile operators. Decoupling of other businesses with traditional LTE commercial business by assigning a pool of radio resource in e.g. the licensed spectrum for intended enterprise communities on the needs basis.
a. The intended communities may then have full control how to use the assigned frequency spectrum without showing any information to the spectrum provider.
b. Only the radio node 13 requires network user identifier tag; for the wireless device 10, no network user identifier tag is required.

Embodiments herein support C-MTC in 3GPP LTE evolution context.

Embodiments herein support possibility to support mobility for the wireless devices that do not support a mobility functionality;

Embodiments herein further provide a more flexible network architecture allowing more efficient resource utilization as the wireless communication network is deployed based on not only the service characteristics but also locations of the wireless devices.

A separate radio node enables independent feature development. Thus, ultra-reliability with lower implementation and verification cost is possible.

Specifically for C-MTC services, the following advantages may be:
c. Larger coverage with higher processing power to control multiple C-MTC resource allocation.
d. With direct communication between wireless devices, Ultra short latency is supported.

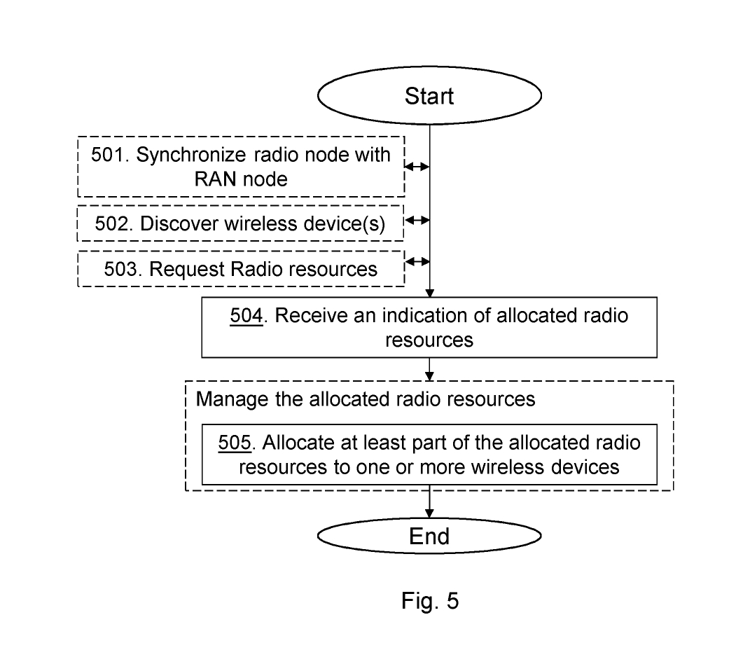

The method actions performed by the radio node 13, for managing communication of one or more wireless devices 10 within the wireless communication network 1 according to some embodiments will now be described with reference to a flowchart depicted in FIG. 5. The actions do not have to be taken in the order stated below, but may be taken in any suitable order. Actions performed in some embodiments are marked with dashed boxes. The wireless communication network 1 comprises the radio access network node 12 serving the radio node 13.

Action 501. The radio node 13 may synchronize the radio node 13 with the radio access network node 12, e.g. when setting up the radio node 13 or start operating the radio node 13.

Action 502. The radio node 13 may discover the the wireless device or wireless devices.

Action 503. The radio node 13 may request radio resources e.g. frequency spectrum and/or time slots of the radio access network node 12 based on e.g. a radio resource usage for communication and/or type of the wireless devices served by the radio node 13.

Action 504. The radio node 13 receives the indication of radio resources out of the total spectrum of radio resources controlled by the radio access network node 12 for communication over the first radio interface using the first radio access technology. The indicated radio resources are allocated to the radio node 13 from the radio access network node 12 for communication over the second radio interface. The second radio interface uses the second radio access technology being different than the first radio access technology. The total spectrum of radio resources may be radio resources for communication using a licensed spectrum. The radio node 13 may get assigned radio resources from the radio access network node 12 both frequency wise and/or time wise. On time wise the radio node 13 may get the radio resources periodically and within a certain period, e.g. depending on the service/device type the radio node 13 supports. On frequency wise it could be a set of continuous or non-continuous frequency spectrum that may be assigned to the radio node 13. Even the processing power could be assigned to the radio node 13 and license controlled. The allocated radio resources may be dedicated for a specific industry.

Action 505. The radio node 13 allocates at least part of the indicated radio resources for communication to and/or from the one or more wireless devices 10 over the second radio interface. The radio resources may be frequency spectrum and/or transmit power, time slots etc. The radio access network node 12 may e.g. assign a maximum transmit power of radio node 13 based on a potential interference situation. The radio node 13 may thus manage the allocated radio resources within radio coverage of the radio node 13 e.g. by allocating the at least part of the indicated radio resources. The allocated radio resources may be related to transmit power and the radio node 13 may thus manage the allocated radio resources by controlling the transmit power as indicated by the radio access network node 12. The radio node may be a stand-alone node with communication interfaces for the first radio interface and the second radio interface, thus, a non-complex solution is herein provided that is easy to set up and operate.

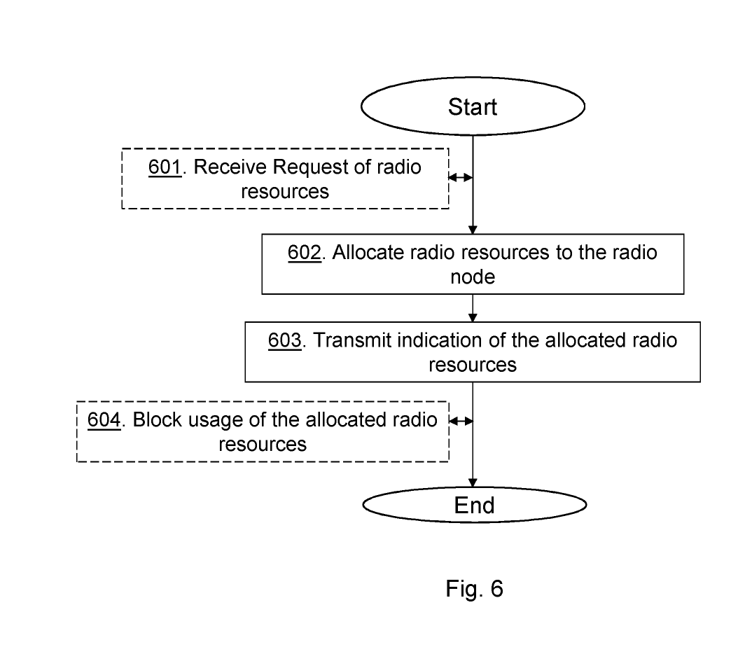

The method actions performed by the radio access network node 12 for handling communication of the one or more wireless devices within the wireless communication network 1 according to some embodiments will now be described with reference to a flowchart depicted in FIG. 6. The actions do not have to be taken in the order stated below, but may be taken in any suitable order. Actions performed in some embodiments are marked with dashed boxes. The radio access network node 12 is serving the radio node 13 in the wireless communication network.

Action 601. The radio access network node 12 may receive a request for radio resources from the radio node 13.

Action 602. The radio access network node 12 allocates radio resources dedicated for the radio node 13, which allocated radio resources are out of the total spectrum of radio resources controlled by the radio access network node 12 for communication over the first radio interface using the first radio access technology. The radio resources are allocated to the radio node 13 from the radio access network node 12 for communication over the second radio interface, which second radio interface uses the second radio access technology being different than the first radio access technology. The radio access network node 12 may allocate the first group of radio resources out of the total spectrum of radio resources for communication within the radio coverage of the radio access network node 12, and may allocate the second group of radio resources out of the total spectrum of radio resources for communication within the radio coverage of the radio node 13 but at least partly outside the radio coverage of the radio access network node 12.

Action 603. The radio access network node 12 transmits to the radio node 13 the indication of the allocated radio resources.

Action 604. The radio access network node 12 may block usage of the allocated radio resources to be used only by the radio node 13.

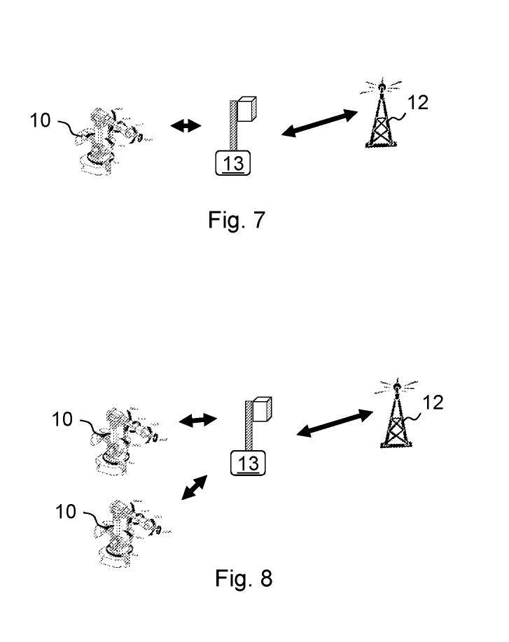

FIG. 7 shows an embodiment wherein the radio node 13 is a control node programmed with a functionality and interface to control a robot operation. The wireless device 10, being a robot device, is not known by the radio access network node 12. A network user identifier tag is needed for the radio node 13 but not for the wireless device 10. The radio node 13 receives the indication of allocated radio resources from the radio access network node 12 and may allocate the radio resources to the wireless device 10 for communication.

FIG. 8 shows an embodiment wherein the radio node 13 comprises a functionality and interface to control multiple robot operations. The radio node 13 may also have the functionality to allocate the radio resources used for communication between two robots, i.e. two wireless devices. The control information and data needed between wireless device 10 and the radio node 13 may be exchanged through e.g. allocated wireless frequency resources. The information of the wireless device 10 is known by the radio node 13 but not the radio access network node 12 nor the wireless communication network. Thus, network user identifier tag may be needed for the radio node 13, but not for the wireless devices 10 within the coverage in the radio node 13.

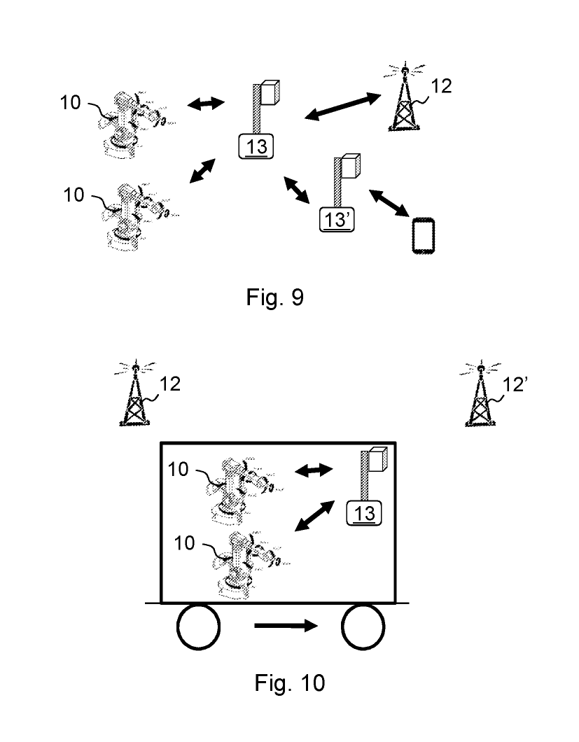

FIG. 9 shows communication between wireless devices in coverage of different radio nodes 13,13′. Functionality of routing and relaying information is possible for the radio node 13 following e.g. a 3GPP D2D communication protocol, whereby the second radio node 13′ relays data to/from a wireless device. UE context information of each radio node within the proximity area is held and exchanged between the radio nodes. Network user identifier tags may be needed for the radio nodes 13,13′, but not for the wireless devices 10 within the coverage in the radio nodes 13,13′.

FIG. 10 shows that with the radio node 13, it is possible to provide mobility support for the wireless device 10 that do not support mobility. Hence, when the radio node 13 is travelling towards a second radio access network node 12′ this may be handed over to the second radio access network node 12′ but as the wireless devices are still locally connected to the radio node 13 the wireless devices are unaware of the handover.

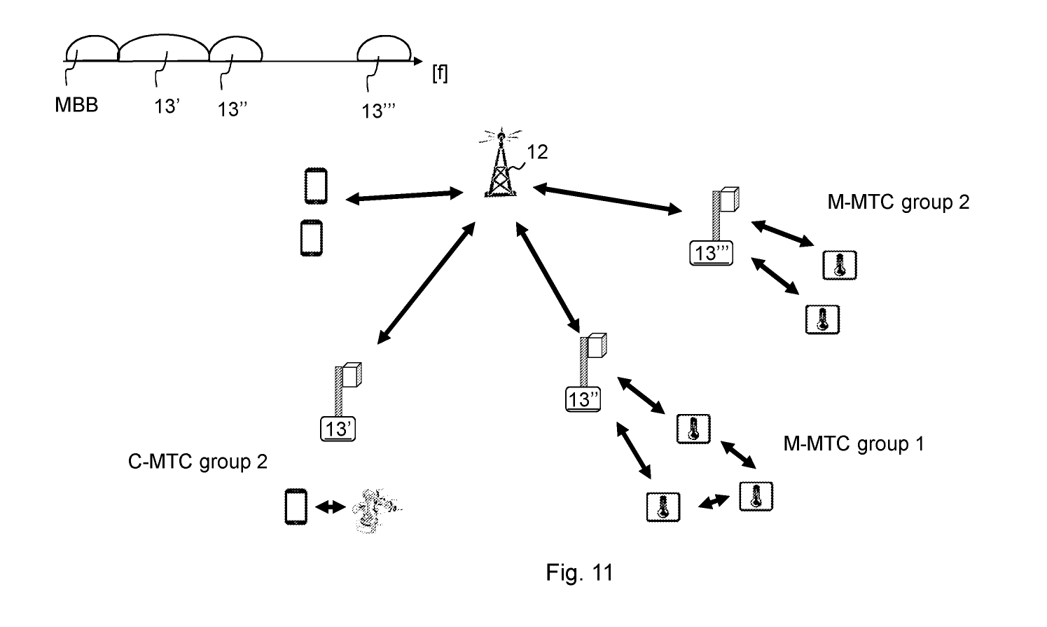

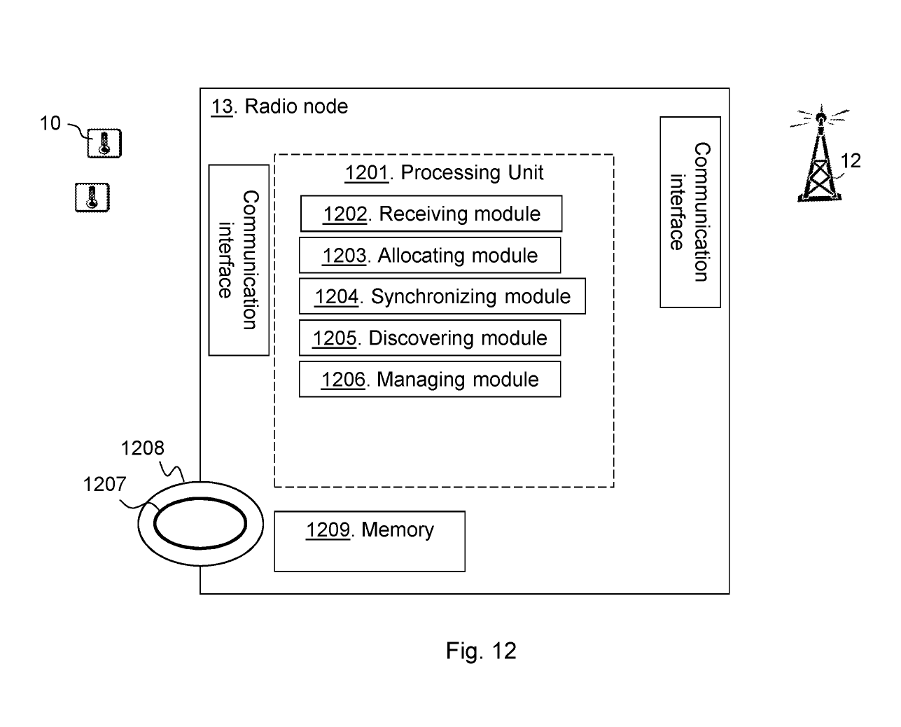

FIG. 11 shows an embodiment wherein the radio node 13 may be configured to support multiple applications with different characteristics. The radio node 13 can be configured to support multiple wireless devices with “Star” topology with network deployment, e.g. a C-MTC group 1. The radio node 13 is herein exemplified as three different radio nodes; a first radio node 13′, a second radio node 13″ and a third radio node 13′″. In a typical use case a central controller within the first radio node 13′ controls radio resources for services for the C-MTC devices. For example, the first radio node 13′ may be configured to allocate radio resources for a direct communication between different C-MTC devices, e.g. a C-MTC group 2. Furthermore, the second radio node 13″ may be configured as an advanced relay node to support M-MTC applications in the extended coverage range, e.g. M-MTC group 1 in the FIG. 11. The potential benefit with this deployment is a more efficient resource utilization. The excessive transmission repetitions specified in 3GPP to obtain extended coverage for about 20 dB may be avoided. More efficient resource utilization can thus be obtained. The third radio node 13′″ may be configured to work in an unlicensed spectrum and allocating radio resources to wireless devices over the unlicensed frequency spectrum, for example M-MTC group 2 in the FIG. 11 may be using LoRa to support M-MTC application in unlicensed spectrum. The third radio node 13′″ may support both LoRa and LTE in unlicensed spectrum. The radio access network node 12 may allocate the unlicensed spectrum to the radio node 13′″ following 3GPP LTE standard, and within the allocated spectrum, the radio node 13′″ may allocate the radio resources to the wireless devices. The benefits of this deployment are: Interference in unlicensed spectrum potentially can be partly controlled by the radio access network node 12; a large scale coverage of LoRa only supported wireless devices can be provided by LTE network; Thus, the radio node 13 according to embodiments herein may support both LoRa in unlicensed spectrum and LTE in licensed spectrum, if wireless devices support both technologies, seamless aggregation of different carriers operating different technologies, e.g. one for LTE technology and one for LoRa technology, is possible. The radio node 13 can be configured to support other technologies, such as NX, SigFox, and any industry defined protocols. The proposed solution may as stated above also be used in an unlicensed frequency spectrum of the first RAT and the usage of radio resources for the first RAT and the second RAT is coordinated and controlled by the radio access network node 12. With the knowledge of a group of wireless devices and the frequency and time resources used by the group of wireless devices, the radio access network node 12 will be able to control interference and allocate the radio resource pool of an unlicensed frequency spectrum to the radio node 13, and the radio node 13 will allocate at least a part of the radio resource pool to the group of wireless devices. Better QoS may be provided since the network is able to control network interference in the unlicensed band. That is, in this embodiment, the unlicensed spectrum is coordinated to avoid interference between the first RAT and the second RAT and that is not the case for prior art solutions.

Embodiments herein may decouple the first radio interface between radio access network node 12 and the radio node 13, and the second radio interface between the radio node 13 and the wireless device 10 or wireless devices. Embodiments allow different protocol running in different interfaces based on needs. In the above example, since LTE regular allocation is applied for all radio nodes, denoted MBB in the frequency spectrum, the LTE radio access network node 12 does not need to support coexistence of different technologies in the same radio access network node 12. Embodiments herein provide a less complex software architecture and a cost efficient software design and verification process is possible.

Logical Functional Node

The radio node 13 may be a logical functionality node comprising software, which radio node 13 can be a stand-alone node with extra hardware such as antennas and digital units. It can alternatively be a part of the functionalities of the radio access network node 12, or a part of functionalities of the wireless device 10. When it is collocated with the radio access network node 12, it indicates that different spectrum is allocated for software modules which are intended for different industries. Being integrated with the radio access network node 12, the radio node 13 may act as a partition of resources of the radio access network node 12 to support e.g. a group of wireless devices, e.g. C-MTC wireless devices. The first radio interface may thus be either a wireless air interface or a logical interface within the radio access network node 12. When the radio node 13 is integrated with the wireless device 10, the functionality to control radio resource allocation of tethering wireless devices may be supported by the wireless device 10. The radio node 13 may further have the functionality to aggregate information from multiple wireless devices, to further encode and transmit via the first radio interface to the radio access network node 12. In such case, the first radio interface between the radio node 13 and the radio access network node 12 is operating as a backhaul connection, specifically for supporting NB-LTE wireless devices with extended coverage, wherein better radio resource efficiency is possible. The coverage for different applications can be provided by both the radio access network node 12 and the radio node 13. Large scale coverage for different industry is possible achieved based on the needs.

Depending on the wireless device protocol, potentially the radio node 13 may be used as a repeater or relaying node with a local radio resource management function to enhance coverage and radio resource efficiency. Thus, the radio node 13 may perform e.g. scheduling, coding and decoding processes.

FIG. 12 is a block diagram depicting the radio node 13 for managing communication of one or more wireless devices within the wireless communication network 1. The wireless communication network 1 comprises the radio access network node 12 configured to serve the radio node 13.

The radio node 13 may comprise a processing unit 1201, e.g. one or more processors, being configured to perform the methods herein.

The radio node 13 comprises a receiving module 1202. The radio node 13, the processing unit 1201, and/or the receiving module 1202 may be configured to receive the indication of radio resources out of the total spectrum of radio resources controlled by the radio access network node 12 for communication over the first radio interface using the first radio access technology. The indicated radio resources are allocated to the radio node 13 from the radio access network node 12 for communication over the second radio interface. The second radio interface is configured to use the second radio access technology being different than the first radio access technology. The total spectrum of radio resources may be radio resources for communication using the licensed spectrum.

The radio node 13 comprises an allocating module 1203. The radio node 13, the processing unit 1201, and/or the allocating module 1203 may be configured to allocate at least a part of the indicated radio resources for communication to and/or from the one or more wireless devices over the second radio interface. The allocated radio resources may be dedicated for a specific industry.

The radio node 13 may comprise a synchronizing module 1204. The radio node 13, the processing unit 1201, and/or the synchronizing module 1204 may be configured to synchronize the radio node 13 with the radio access network node 12.

The radio node 13 may comprise a discovering module 1205. The radio node 13, the processing unit 1201, and/or the discovering module 1205 may be configured to discover the wireless device or wireless devices.

The radio node 13 may comprise a managing module 1206. The radio node 13, the processing unit 1201, and/or the managing module 1206 may be configured to manage the allocated radio resources within radio coverage of the radio node 13. For example, the radio node 13, the processing unit 1201, and/or the managing module 1206 may be configured to allocate the at least part of the allocated radio resources. The allocated radio resources may be related to transmit power and the radio node 13, the processing unit 1201, and/or the managing module 1206 may be configured to manage the allocated radio resources by being configured to control the transmit power as indicated by the radio access network node 12.

An objective of embodiments herein may be to provide a low cost node, the radio node 13, which is portable and easily maintained. The radio node 13 may be a physical node containing radio, antenna, and digital processing unit. But also the radio node 13 can be a logical node, which can be collocated with the radio access network node 12 in the wireless communication network. The radio node may hence be a stand-alone node with communication interfaces for the first radio interface and the second radio interface, thus, a non-complex solution is herein provided that is easy to set up and operate.

The methods according to the embodiments described herein for the radio node 13 are respectively implemented by means of e.g. a computer program 1207 or a computer program product, comprising instructions, i.e., software code portions, which, when executed on at least one processor, cause the at least one processor to carry out the actions described herein, as performed by the radio node 13. The computer program 1207 may be stored on a computer-readable storage medium 1208, e.g. a disc or similar. The computer-readable storage medium 1208, having stored thereon the computer program, may comprise the instructions which, when executed on at least one processor, cause the at least one processor to carry out the actions described herein, as performed by the radio node 13. In some embodiments, the computer-readable storage medium may be a non-transitory computer-readable storage medium.

The radio node 13 further comprises a memory 1209. The memory comprises one or more units to be used to store data on, such as radio resources, scheduling information, identities of wireless devices, transmit power, context of wireless devices, applications to perform the methods disclosed herein when being executed, and similar.

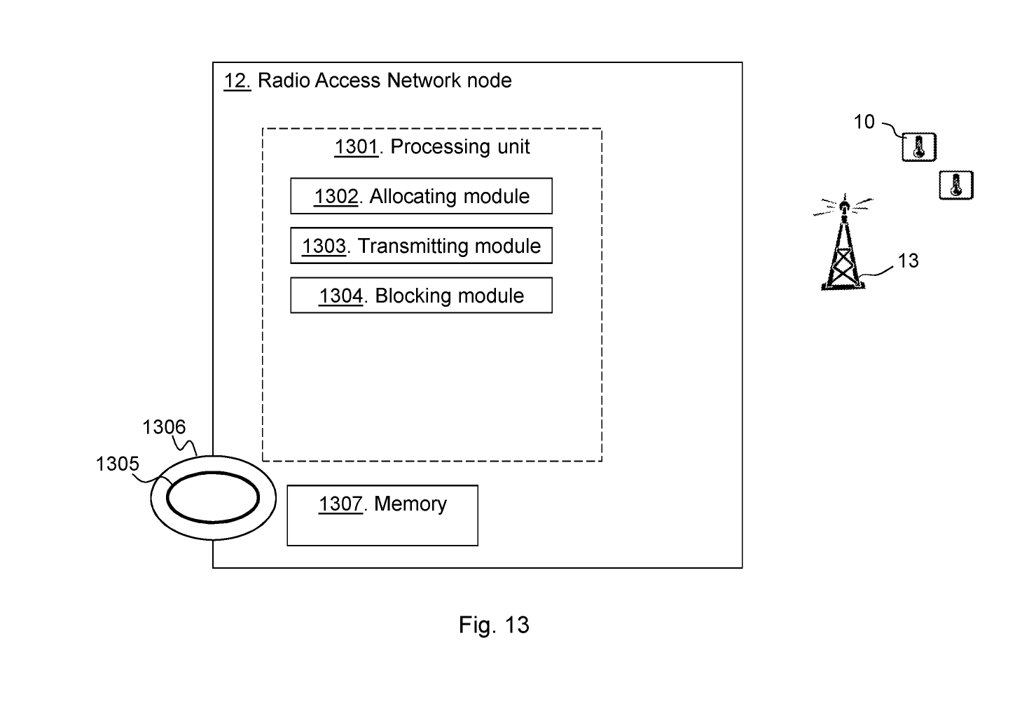

FIG. 13 is a block diagram depicting the radio access network node 12 for handling communication of the one or more wireless devices within the wireless communication network 1. The radio access network node 12 is configured to serve the radio node 13 in the wireless communication network 1.

The radio access network node 12 may comprise a processing unit 1301, e.g. one or more processors, being configured to perform the methods herein.

The radio access network node 12 comprises an allocating module 1302. The radio access network node 12, the processing unit 1301, and/or the allocating module 1302 may be configured to allocate radio resources dedicated for the radio node 13, which allocated radio resources are out of the total spectrum of radio resources controlled by the radio access network node 12 for communication over the first radio interface configured to use the first radio access technology. The radio resources are allocated to the radio node 13 from the radio access network node 12 for communication over the second radio interface, which second radio interface is configured to use the second radio access technology being different than the first radio access technology. The radio access network node 12, the processing unit 1301, and/or the allocating module 1302 may be configured to allocate radio resources by being configured to allocate the first group of radio resources out of the total spectrum of radio resources for communication within the radio coverage of the radio access network node 12, and to allocate the second group of radio resources out of the total spectrum of radio resources for communication within the radio coverage of the radio node 13 but at least partly outside the radio coverage of the radio access network node 12.

The radio access network node 12 comprises a transmitting module 1303.

The radio access network node 12, the processing unit 1301, and/or the transmitting module 1303 may be configured to transmit, to the radio node 13, the indication of the allocated radio resources.

The radio access network node 12 may comprise a blocking module 1304.

The radio access network node 12, the processing unit 1301, and/or the blocking module 1304 may be configured to block usage of the allocated radio resources to be used only by the radio node 13.

The methods according to the embodiments described herein for the radio access network node 12 are respectively implemented by means of e.g. a computer program 1305 or a computer program product, comprising instructions, i.e., software code portions, which, when executed on at least one processor, cause the at least one processor to carry out the actions described herein, as performed by the radio access network node 12.

The computer program 1305 may be stored on a computer-readable storage medium 1306, e.g. a disc or similar. The computer-readable storage medium 1306, having stored thereon the computer program, may comprise the instructions which, when executed on at least one processor, cause the at least one processor to carry out the actions described herein, as performed by the radio access network node 12. In some embodiments, the computer-readable storage medium may be a non-transitory computer-readable storage medium.

The radio node 13 further comprises a memory 1307. The memory comprises one or more units to be used to store data on, such as radio resources, scheduling information, identities of radio nodes, transmit power, applications to perform the methods disclosed herein when being executed, and similar.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-24. (canceled)

25. A method, performed by a radio node, for managing communication of one or more wireless devices within a wireless communication network; wherein the wireless communication network comprises a radio access network node serving the radio node;
the method comprising the radio node:
receiving an indication of radio resources out of a total spectrum of radio resources controlled by the radio access network node for communication over a first radio interface using a first radio access technology, wherein the indicated radio resources are allocated to the radio node from the radio access network node for communication over a second radio interface, the second radio interface using a second radio access technology different than the first radio access technology; and
allocating at least part of the indicated radio resources for communication to and/or from the one or more wireless devices over the second radio interface.

26. The method of claim 25, wherein the total spectrum of radio resources are radio resources for communication using a licensed spectrum.

27. The method of claim 25, further comprising synchronizing the radio node with the radio access network node.

28. The method of claim 25, further comprising discovering the wireless device or wireless devices.

29. The method of claim 25, further comprising managing the allocated radio resources within radio coverage of the radio node.

30. The method of claim 29:
wherein the allocated radio resources are related to transmit power; and
wherein the managing comprises controlling the transmit power as indicated by the radio access network node.

31. The method of claim 25, wherein the allocated radio resources are dedicated for a specific industry.

32. The method of claim 25, wherein the radio node is a stand-alone node with communication interfaces for the first radio interface and the second radio interface.

33. A method, performed by radio access network node, for handling communication of one or more wireless devices within a wireless communication network, wherein the radio access network node is serving a radio node in the wireless communication network; the method comprising the radio access network node:
allocating radio resources dedicated for the radio node, the allocated radio resources being out of a total spectrum of radio resources controlled by the radio access network node for communication over a first radio interface using a first radio access technology; wherein the radio resources are allocated to the radio node from the radio access network node for communication over a second radio interface, the second radio interface using a second radio access technology different than the first radio access technology; and
transmitting, to the radio node, an indication of the allocated radio resources.

34. The method of claim 33, wherein the allocating comprises:
allocating a first group of radio resources out of the total spectrum of radio resources for communication within a radio coverage of the radio access network node; and
allocating a second group of radio resources out of the total spectrum of radio resources for communication within a radio coverage of the radio node but at least partly outside the radio coverage of the radio access network node.

35. The method of claim 33, further comprising blocking usage of the allocated radio resources to be used only by the radio node.

36. A radio node for managing communication of one or more wireless devices within a wireless communication network; wherein the wireless communication network comprises a radio access network node configured to serve the radio node; the radio node comprising:
processing circuitry;
memory containing instructions executable by the processing circuitry whereby the radio node is operative to:
receive an indication of radio resources out of a total spectrum of radio resources controlled by the radio access network node for communication over a first radio interface using a first radio access technology, wherein the indicated radio resources are allocated to the radio node from the radio access network node for communication over a second radio interface, the second radio interface using a second radio access technology different than the first radio access technology; and
allocate at least a part of the indicated radio resources for communication to and/or from the one or more wireless devices over the second radio interface.

37. The radio node of claim 36, wherein the total spectrum of radio resources are radio resources for communication using a licensed spectrum.

38. The radio node of claim 36, wherein the instructions are such that the radio node is operative to synchronize the radio node with the radio access network node.

39. The radio node of claim 36, wherein the radio node is a stand-alone node with communication interfaces for the first radio interface and the second radio interface.

40. A radio access network node for handling communication of one or more wireless devices within a wireless communication network, wherein the radio access network node is configured to serve a radio node in the wireless communication network; the radio access network comprising:
processing circuitry;
memory containing instructions executable by the processing circuitry whereby the radio access network node is operative to:
allocate radio resources dedicated for the radio node, the allocated radio resources being out of a total spectrum of radio resources controlled by the radio access network node for communication over a first radio interface configured to use a first radio access technology, wherein the radio resources are allocated to the radio node from the radio access network node for communication over a second radio interface, the second radio interface using a second radio access technology different than the first radio access technology; and
transmit, to the radio node, an indication of the allocated radio resources.

41. The radio access network node of claim 40, wherein the instructions are such that the radio access network node is operative to allocate the radio resources by:
allocating a first group of radio resources out of the total spectrum of radio resources for communication within a radio coverage of the radio access network node; and
allocating a second group of radio resources out of the total spectrum of radio resources for communication within a radio coverage of the radio node but at least partly outside the radio coverage of the radio access network node.

42. The radio access network node of claim 40, wherein the instructions are such that the radio access network node is operative to block usage of the allocated radio resources to be used only by the radio node.

43. A non-transitory computer readable recording medium storing a computer program product for controlling a radio node for managing communication of one or more wireless devices within a wireless communication network; wherein the wireless communication network comprises a radio access network node serving the radio node; the computer program product comprising software instructions which, when run on processing circuitry of the radio node, causes the radio node to:
receive an indication of radio resources out of a total spectrum of radio resources controlled by the radio access network node for communication over a first radio interface using a first radio access technology, wherein the indicated radio resources are allocated to the radio node from the radio access network node for communication over a second radio interface, the second radio interface using a second radio access technology different than the first radio access technology; and
allocate at least part of the indicated radio resources for communication to and/or from the one or more wireless devices over the second radio interface.

44. A non-transitory computer readable recording medium storing a computer program product for controlling a radio access network node for handling communication of one or more wireless devices within a wireless communication network, wherein the radio access network node is serving a radio node in the wireless communication network; the computer program product comprising software instructions which, when run on processing circuitry of the radio access network node, causes the radio access network node to:
allocate radio resources dedicated for the radio node, the allocated radio resources being out of a total spectrum of radio resources controlled by the radio access network node for communication over a first radio interface using a first radio access technology; wherein the radio resources are allocated to the radio node from the radio access network node for communication over a second radio interface, the second radio interface using a second radio access technology different than the first radio access technology; and
transmit, to the radio node, an indication of the allocated radio resources.
